(19) United States
(12) Patent Application Publication
(10) Pub. No.: US 2026/0247153 A1
(43) Pub. Date: Aug. 20, 2026

(54) INTERNET GATEWAY WITH SOUND AND VIDEO MONITORING FOR SECURITY AND SAFETY APPLICATIONS

(71) Applicant: MaxLinear, Inc., Carlsbad, CA (US)

(72) Inventors: Saju Palayur, Poway, CA (US); Khan M. Muneer, San Diego, CA (US)

(73) Assignee: MaxLinear, Inc., Carlsbad, CA (US)

(21) Appl. No.: 19/542,572

(22) Filed: Feb. 17, 2026

Related U.S. Application Data
(60) Provisional application No. 63/759,127, filed on Feb. 15, 2025.
(60) Provisional application No. 63/887,861, filed on Sep. 25, 2025.

(51) Int. Cl. H04W 12/121

(52) U.S. Cl. CPC H04W 12/121

(57) ABSTRACT

A system may include a sound sensor that may monitor a sound; a camera that may capture one or more of an image or a video; and a device including a processing device. The processing device may classify the sound based on one or more of a security condition or a safety condition using one or more of artificial intelligence (AI) or machine learning (ML), in which the sound may be an intrusion-indicating sound. The processing device may perform analysis of one or more of the image or the video to verify the one or more of the security condition or the safety condition using one or more of AI or ML to detect an object, in which the object may be an intrusion-indicating object. The device may include one or more of an internet gateway or an access point (AP).

### RELATED APPLICATION

This application claims the benefit of U.S. Provisional Application No. 63/759,127, filed Feb. 15, 2025 and U.S. Provisional Application No. 63/887,861, filed Sep. 25, 2025, the disclosures of which are incorporated herein by reference in their entireties for all purposes.

The examples discussed in the present disclosure are related to internet gateways with real time sound and video monitoring for security and safety applications.

### BACKGROUND

Unless otherwise indicated herein, the materials described herein are not prior art to the claims in the present application and are not admitted to be prior art by inclusion in this section.

An access point (AP), is a networking hardware device that allows other Wi-Fi® devices to connect to a wired network. As a standalone device, the AP may have a wired connection to a router, but, in a wireless router, it can also be an integral component of the router itself. There are many wireless data standards that have been introduced for wireless access point and wireless router technology such as 802.11a, 802.11b, 801.11g, 802.11n (Wi-Fi® 4), 802.11ac (Wi-Fi® 5), 802.11ax (Wi-Fi® 6), and so forth.

The subject matter claimed in the present disclosure is not limited to examples that solve any disadvantages or that operate only in environments such as those described above. Rather, this background is only provided to illustrate one example technology area where some examples described in the present disclosure may be practiced.

### SUMMARY

In some examples, a system may include a sound sensor that may monitor a sound; a camera that may capture one or more of an image or a video; and a device including a processing device. The processing device may classify the sound based on one or more of a security condition or a safety condition using one or more of artificial intelligence (AI) or machine learning (ML), in which the sound may be an intrusion-indicating sound. The processing device may perform analysis of one or more of the image or the video to verify the one or more of the security condition or the safety condition using one or more of AI or ML to detect an object, in which the object may be an intrusion-indicating object. The device may include one or more of an internet gateway or an access point (AP).

In some examples, a method for intrusion detection may include monitoring, at an AP, a sound. The method may include monitoring, at the AP, one or more of an image or a video. The method may include classifying, at the AP, the sound based on one or more of a security condition or a safety condition using one or more of AI or ML, in which the sound may be an intrusion-indicating sound. The method may include performing, at the AP, analysis of one or more of the image or the video to verify the one or more of the security condition or the safety condition using one or more of AI or ML to detect an object, in which the object may be an intrusion-indicating object.

In some examples, an AP may include a processing device. The processing device may monitor, at an AP, a sound. The processing device may monitor, at the AP, one or more of an image or a video. The processing device may classify, at the AP, the sound based on one or more of a security condition or a safety condition using one or more of artificial intelligence (AI) or machine learning (ML), in which the sound may be an intrusion-indicating sound. The processing device may perform, at the AP, analysis of one or more of the image or the video to verify the one or more of the security condition or the safety condition, using one or more of AI or ML to detect an object, in which the object may be an intrusion-indicating object.

The objects and advantages of the examples will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Examples will be described and explained with additional specificity and detail through the use of the accompanying drawings in which:

FIG. 1 illustrates an example block diagram for an internet gateway with integrated sound and video monitoring for security and safety applications.

FIG. 2 illustrates an example block diagram for an internet gateway with integrated sound and video monitoring for security and safety applications.

FIG. 3A illustrates an example block diagram for an internet gateway with integrated sound and video monitoring for security and safety applications.

FIG. 3B illustrates an example diagram of video processing.

FIG. 3C illustrates an example diagram of audio processing.

FIG. 4 illustrates an example process flow for generating a trained model.

FIG. 5 illustrates a process flow of an internet gateway with integrated sound and video monitoring for security and safety applications.

FIG. 6 illustrates a process flow of an internet gateway with integrated sound and video monitoring for security and safety applications.

FIG. 7 illustrates a block diagram of an example system operable for integrated sound and video monitoring.

FIG. 8 illustrates a diagrammatic representation of a machine in the example form of a computing device within which a set of instructions, for causing the machine to perform any one or more of the methods discussed herein, may be executed.

### DESCRIPTION

Wireless access points and internet gateways may be used to provide internet connectivity but may not have additional functionality. Wireless access points and internet gateways may have access to various types of data, but may not provide enhanced functionality related to the data. Therefore, methods of enhancing wireless access points and internet gateways may be useful.

An internet gateway may be connected to various devices (e.g., internet of things (IoT) devices). Data from the various devices may be sent to the internet gateway and may be integrated to provide additional functionality for the internet gateway.

Internet gateways may be enhanced with real-time sound and video monitoring for security and safety applications. The system may detect abnormal noises (e.g., smoke alarms, baby cries, glass breaking) and perform image/video analysis for intrusion detection.

The gateway may incorporate: (1) sound monitoring e.g., artificial intelligence (AI)-driven detection of smoke alarms, sirens, baby cries, (2) video/image Processing, e.g., AI-based object detection for security monitoring, (3) edge AI processing e.g., local computation to reduce cloud reliance and enhance privacy, and/or (4) user alerts & integration: real-time mobile notifications and smart home automation.

The gateway may have several features. For example, the gateway may enhance home & business security with AI-powered monitoring. The gateway may work during internet & power failures due to local processing. For example, the gateway may integrate with IoT devices for automation and real-time alerts.

Examples of the present disclosure will be explained with reference to the accompanying drawings.

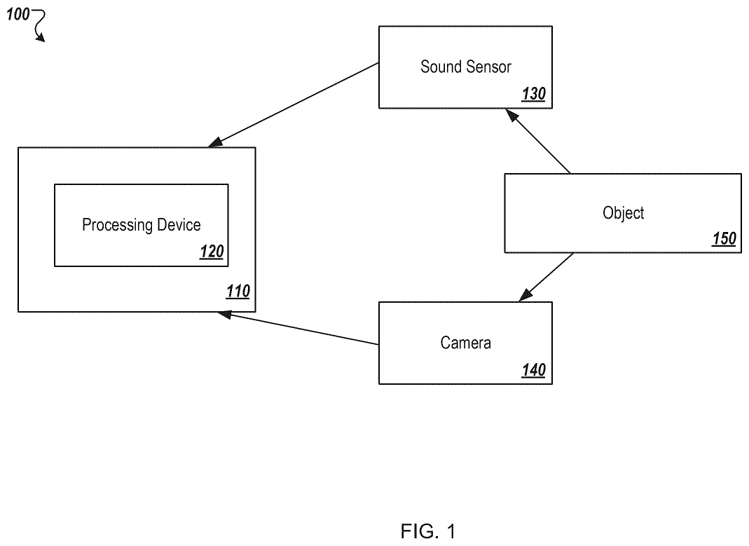

The example block diagram 100 in FIG. 1 illustrates a device 110 (e.g., access point (AP)) including a processing device 120. The processing device 120 may monitor, at the AP, a sound (e.g., using a sound sensor 130). The processing device 120 may monitor, at the AP, one or more of an image or a video (e.g., using a camera 140). The processing device 120 may classify, at the AP, the sound based on one or more of a security condition or a safety condition using one or more of artificial intelligence (AI) or machine learning (ML). The sound may be an intrusion-indicating sound. For example, the sound may be one or more of a smoke alarm, a baby cry, glass breaking, a gun-shot, or the like.

The processing device 120 may perform, at the AP, analysis of one or more of the image or the video to verify the one or more of the security condition or the safety condition. The processing device may use one or more of AI or ML to detect an object 150. The object 150 may be an intrusion-indicating object. The intrusion-indicating object may be one or more of smoke, broken glass, a weapon, an unknown person, or the like.

In other examples, a system may include a sound sensor 130 that may monitor a sound and/or a camera 140 that may capture one or more of an image or a video and/or a device that may include a processing device. The device 110 may be one or more of an internet gateway or an access point.

The device 110 may classify the sound and perform analysis of the one or more of the image or the video without modifying the processing device 120 when compared to a baseline processing device that does not classify the sound or perform analysis of the one or more of the image or the video. For example, the device 110 may include one or more instructions that when executed by the processing device 120, may classify the sound and perform analysis of the one or more of the image or the video even when the processing device 120 has not been changed from a baseline processing device that does not have the functionality of classifying the sound or performing the analysis. That is, the device 110 may classify the sound and perform the analysis without additional hardware when compared to a baseline device having a baseline processing device. The device 110 may classify the sound and perform the analysis based on a difference in software rather than a difference in hardware.

The processing device 120 may use sound to determine the image/video or may use the image/video to determine the sound. That is, the processing device 120 may classify the sound using one or more of the image or the video; or detect an object in one or more of the image or the video using the sound.

The processing device 120 may receive data from various sources. For example, the processing device may receive data from one or more of an internet of things (IoT) device, a user equipment (UE), or a smart home system. The data may be used to one or more of classify the sound or perform the analysis of the one or more of the image or the video. The processing device 120 may send an alert to one or more of the UE, the IoT device, or the smart home system.

The processing device may be a local device to maintain privacy of the data. For example, when a privacy setting is set to a high level, the data may be restricted to the local network. Alternatively or in addition, when the privacy setting is set to a lower level, the data may be provided to a cloud computing environment for processing.

Modifications, additions, or omissions may be made to the components of FIG. 1 without departing from the scope of the present disclosure.

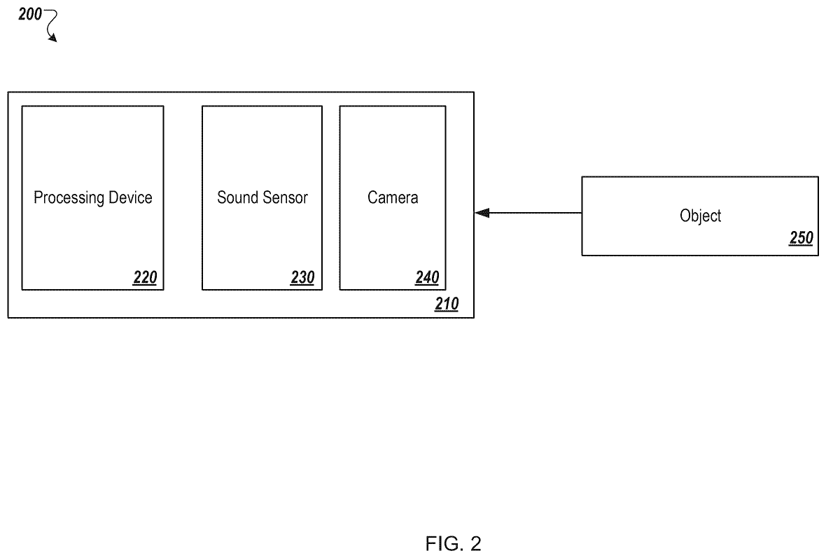

As illustrated in the example block diagram 200 in FIG. 2, the processing device 220, the sound sensor 230, and/or the camera 240 may be integrated into the device 210 (e.g., an access point). The integrated access point may detect a sound associated with an object 250 and may detect image/video associated with the object.

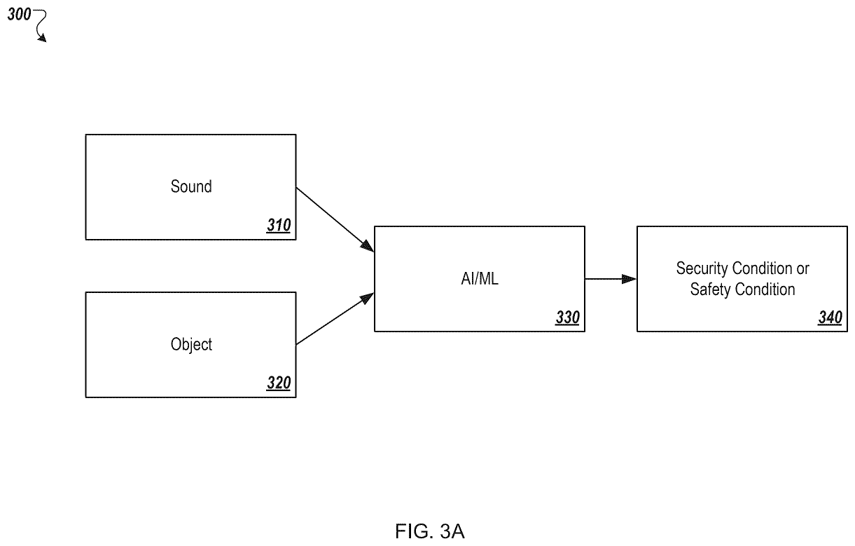

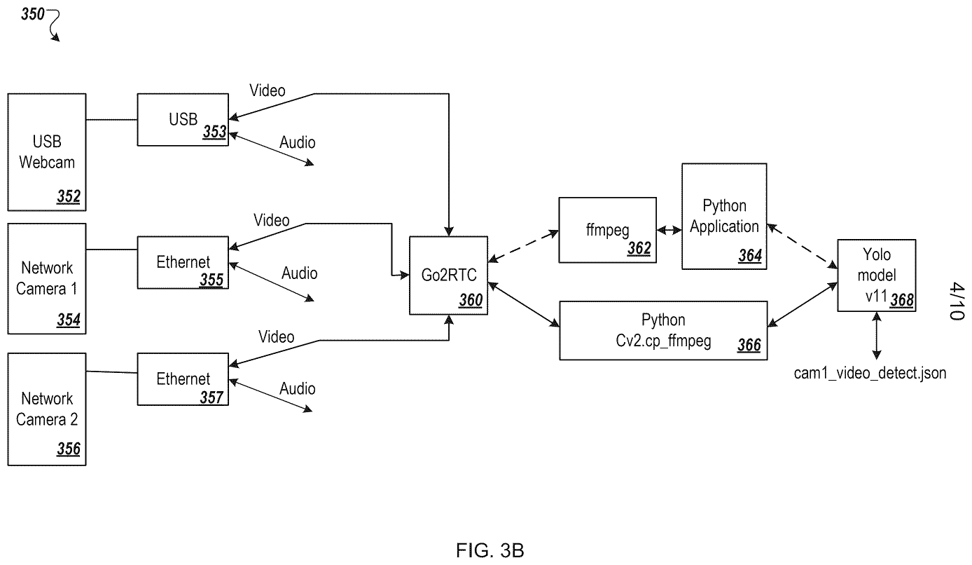

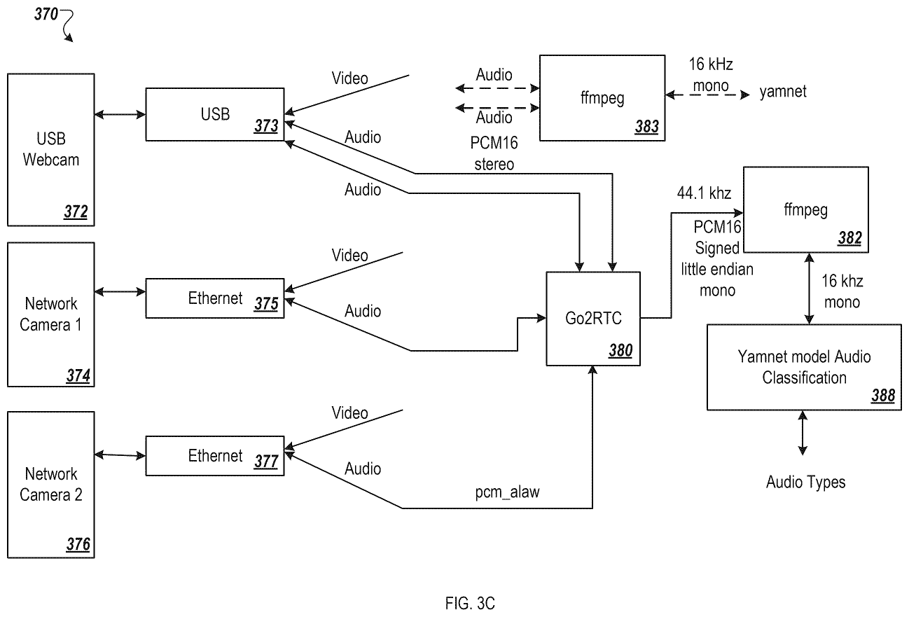

As illustrated in the block diagram 300 in FIG. 3A, a sound 310 and/or an object 320 may be used in artificial intelligence and/or machine learning 330 to determine a security condition (e.g., the presence of an intruder) or a safety condition (e.g., the presence of fire) 340.

Various types of artificial intelligence and/or machine learning may be used to determine the security condition and/or safety condition. The machine learning model may use a deep neural network including one or more of a convolutional neural network or a recurrent neural network. Alternatively or in addition, the machine learning model may use analog deep learning.

Universal Serial Bus (USB) and internet protocol (IP) cameras may be used as intelligent vision sensors with an AI-enabled, low-latency Wi-Fi® router system on Chip (SoC) platform. Using on-chip edge processing, the SoC platform may facilitate real-time video analytics at the source with applications for smart homes, security systems, and next-generation connected applications.

As illustrated in FIG. 3B, the platform 350 may ingest H.264-encoded video streams from USB (e.g., USB Webcam 352) using USB connection 353 and Ethernet-based network cameras (e.g., network camera 1 354 and/or network camera 2 356) using Ethernet connections 355, 357. The platform 350 may support multiple input sources simultaneously and handle formats like H.264 with optional audio. These streams may be routed through go-to-real time communication (Go2RTC) 360 for centralized management. Video decoding may be performed using either fast forward moving picture expert group (FFmpeg) 362 or open computer vision (OpenCV) facilitating flexible processing options. Selected frames may be analyzed using the YOLOv11 object detection model, and detection results may be output in a structured javascript objection notation (JSON) format for easy integration (e.g., cam1_video_detect.json). The platform may be optimized for efficient CPU usage and real-time object detection, with the option to record video streams on the local Wi-Fi® router for future analysis.

Go2RTC 360 may receive and multiplex video and audio streams, delivering them as WebRTC-compatible outputs. GO2RTC 360 may facilitate real-time streaming of camera feeds to downstream applications with minimal latency and seamless integration.

Video processing on the SoC platform may be implemented using: (1) FFmpeg 362 combined with a Python application 364, or (2) openCV's VideoCapture (cv2) (e.g., Python Cv2.cp_ffmpeg 366) leveraging the FFmpeg backend. Frames may be intelligently downsampled to a few per second for object detection to provide a balance between performance and system efficiency. This lightweight approach may provide that Wi-Fi® and router functions run smoothly, while still delivering accurate and timely insights for smart home and surveillance applications. For more demanding use cases, customers may adjust the frame rate based on available system headroom.

The down sampled video frames may be fed into the YOLOv11 model 368 for real-time object detection. Detection results may be saved in a structured JSON format (e.g., cam1_video_detect.json) for downstream analytics and monitoring.

Table 1A and Table 1B summarize system performance under different configurations.

TABLE 1A
Performance Summary

| CPU | | | I/P | | | O/P | | | |
|---|---|---|---|---|---|---|---|---|---|
| Cores | Freq | Load | Streams | Res. | H.264 | Streams | Res. | WebRTC | Storage |
| 4 | 1.8 GHz | 13% | 1 | 1080p | 20fps | 1 | 1080p | 20 | 20fps |
| 4 | 1.8 GHz | | 1 | 1080p | 20fps | 1 | 1080p | 20 | 20fps |
| 4 | 1.8 GHz | 25% | 2 | 1080p | 20fps | 2 | 1080p | 20 | 20fps |
| 2 | 1.8 GHz | 25% | 1 | 1080p | 20fps | 1 | 1080p | 20 | 20fps |
| 2 | 1.8 GHz | | 1 | 1080p | 20fps | 1 | 1080p | 20 | 20fps |
| 2 | 1.8 GHz | 25% | 2 | 1080p | 20fps | 2 | 1080p | 20 | 20fps |

TABLE 1B
Performance Summary

| | |
|---|---|
| Video Recording | Inference @ 2.2fps |

| Res. | WebRTC | Storage | Res. | Time |
|---|---|---|---|---|
| | | | 640p | 0.18 sec |
| 1080p | 20 | 20 fps | | |
| | | | 640p | 0.18 sec |
| | | | 640p | 0.23 sec |
| 1080p | 20 | 20 fps | | |
| | | | 640p | 0.23 sec |

This performance data highlights the capabilities of the Wi-Fi® router SoC chip, which may integrate streaming, video decoding, and AI-based object detection directly on the platform. By leveraging tools like Go2RTC 360, FFmpeg 362, and YOLOv11 model 368, the SoC facilitates real-time, low-latency video analytics using USB webcams (e.g., USB Webcam 352) or IP cameras without external processors or cloud resources. Optimized for performance and power efficiency, the SoC has applications in smart home, surveillance, and edge AI applications.

Wi-Fi® routers may be real-time audio processing hubs using an AI-enabled, low-latency SoC platform. With on-chip edge processing, the platform may use sound-activated services, audio analytics, and security at the network edge. Applications may include smart homes, consumer IoT, and next-generation connected applications.

As illustrated in FIG. 3C, the platform 370 may ingest live audio streams from USB microphones, webcams (e.g., USB webcam 372) using USB connection 373, and Ethernet-based network cameras (e.g., network camera 1 374 and/or network camera 2 376) using Ethernet connections 375, 377. The platform 370 may support simultaneous multi-channel input and handle standard formats such as pulse code modulation 16 (PCM16) stereo and PCM_alaw. These streams may be routed via Go2RTC 380 for centralized, real-time management and interoperability. Audio decoding, resampling, and downmixing may be performed by FFmpeg 382, to facilitate optimal compatibility and preparation for downstream AI inference.

Go2RTC 380 may receive and multiplex multiple audio sources, delivering them to the AI engine in a unified, standardized format. The pre-processing pipeline may include downmixing stereo to mono and resampling to 16 kHz PCM which may be matched to neural network standards. For example, ffmpeg 383 may receiver different audio sources which may be resampled to 16 kHz mono to be provided to yamnet. Alternatively or in addition, GO2RTC may provide PCM 16 signed little endian mono to ffmpeg 382 which may resample to 16 khz mono to be provided to yamnet model audio classification 388. This architecture may support scalable, low-latency audio capture from diverse endpoints throughout the smart home or business.

Audio samples may be streamed to the on-chip AI/ML inference engine, where models like YAMNet (e.g., Yamnet model audio classification 388) may perform multi-class sound event detection in real time. The platform 370 may detect audio events such as glass break, baby crying, gunshot, smoke alarms, and hundreds of other sound categories-facilitating advanced security, automation, and safety applications without cloud processing.

The platform 370 may have several properties. The platform 370 may be localized by having AI processing occur on the Wi-Fi® gateway SoC to provide privacy, security, and ultra-low response times. The platform 370 may be efficient by optimizing for CPU and memory usage, allowing real-time analytics while standard router functions may remain unaffected. The platform may provide for flexible integration by supporting real-time event output in JSON format for downstream integration with home automation, alerting, or monitoring dashboards. Table 2 provides a performance summary for the platform.

TABLE 2
Performance Summary

| | | Audio | | | Event |
|---|---|---|---|---|---|
| Configuration | Channels | Format | Model | Latency | Classes |
| USB Mic | 1 | PCM16 | YAMNet | <200 ms | 500+ |
| | | Mono | | | |
| Network | 2+ | PCM_{—} | YAMNet | <250 ms | 500+ |
| Camera | | ALAW | | | |

The platform may integrate multi-channel audio routing, pre-processing, and AI-based sound event detection directly on the platform. Leveraging Go2RTC 380, FFmpeg 382, and deep learning, the platform allows for real-time, privacy-preserving audio analytics for smarter homes and edge applications without using external processors or cloud resources. Thus, the platform may be used for audio-centric security, automation, and next-generation edge AI solutions.

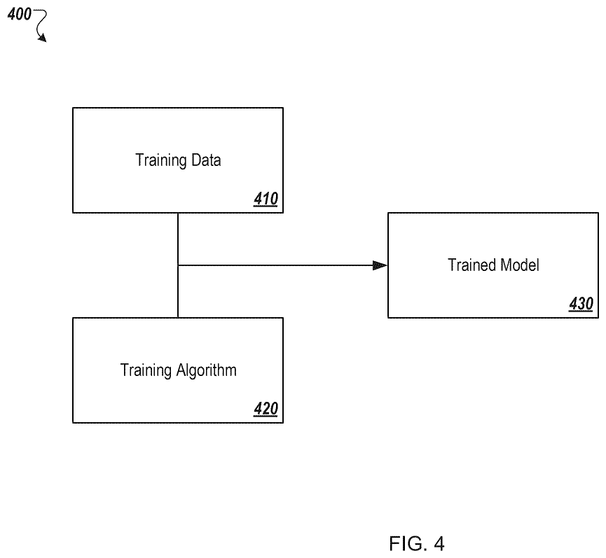

As illustrated in the block diagram 400 in FIG. 4, a processing device may train, at the device, a model based on training data 410 and a selected training algorithm 420 to generate a trained model 430. The processing device may perform, at the device, the one or more of AI or ML using the trained model 430.

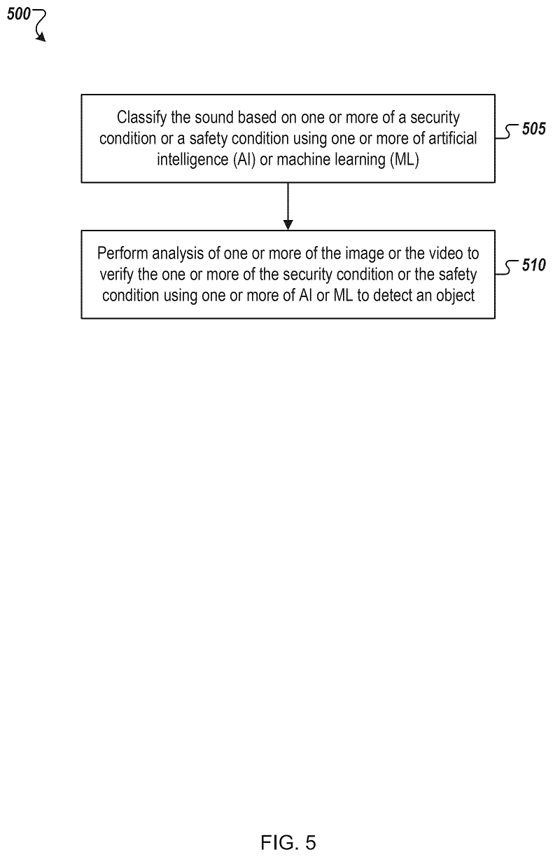

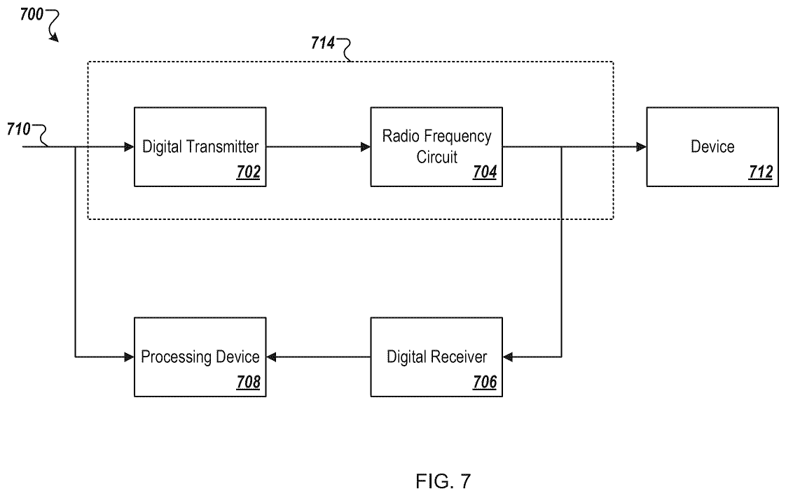

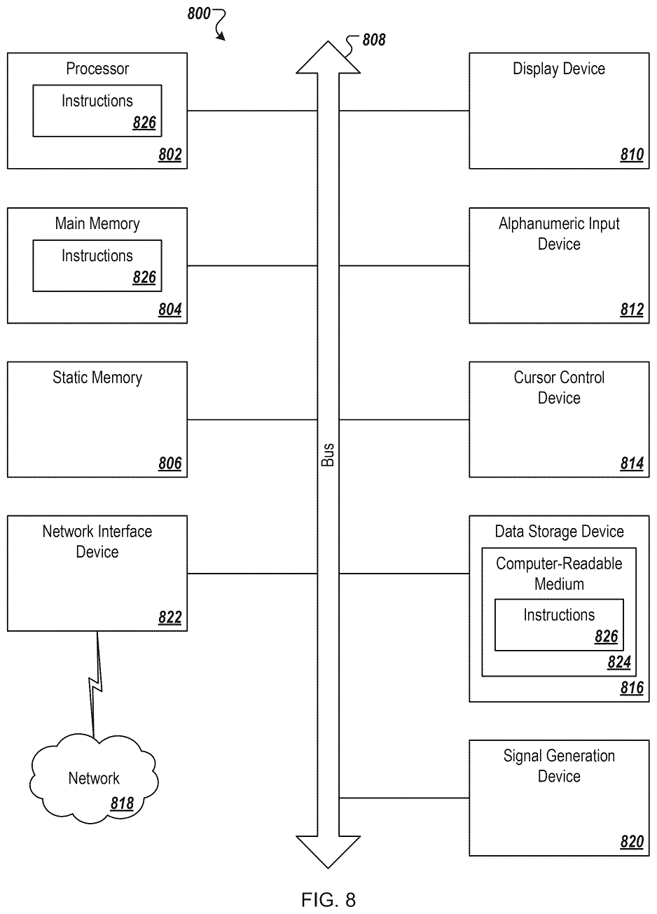

FIG. 5 illustrates a process flow of an example method 500 of an internet gateway with integrated sound and video monitoring for security and safety applications, in accordance with at least one example described in the present disclosure. The method 500 may be arranged in accordance with at least one example described in the present disclosure. The method 500 may be performed by processing logic that may include hardware (circuitry, dedicated logic, etc.), software (such as is run on a computer system or a dedicated machine), or a combination of both, which processing logic may be included in the processing device 802 of FIG. 8, the communication system 700 of FIG. 7, or another device, combination of devices, or systems.

The method 500 may begin at block 505 where the processing logic may classify the sound based on one or more of a security condition or a safety condition using one or more of artificial intelligence (AI) or machine learning (ML). The sound may be an intrusion-indicating sound.

At block 510, the processing logic may perform analysis of one or more of the image or the video to verify the one or more of the security condition or the safety condition, using one or more of AI or ML to detect an object. The object may be an intrusion-indicating object.

Modifications, additions, or omissions may be made to the method 500 without departing from the scope of the present disclosure. For example, in some examples, the method 500 may include any number of other components that may not be explicitly illustrated or described.

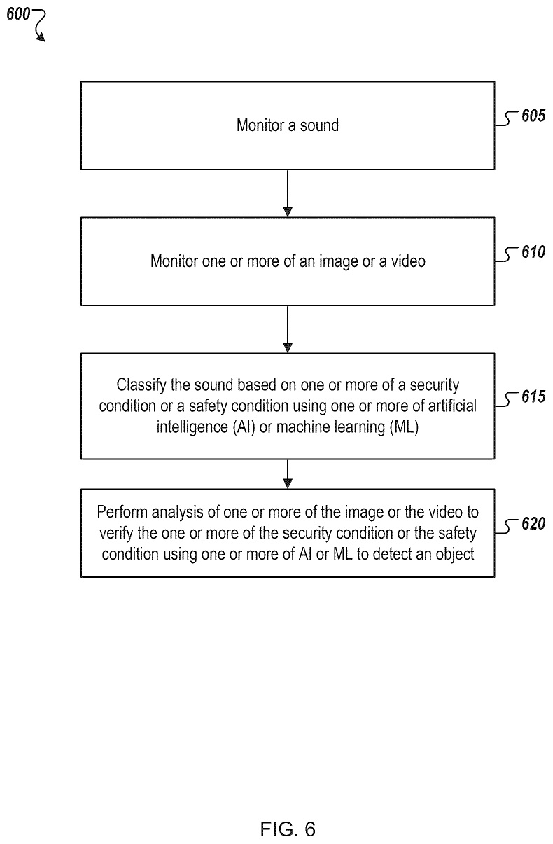

FIG. 6 illustrates a process flow of an example method 600 of an internet gateway with integrated sound and video monitoring for security and safety applications, in accordance with at least one example described in the present disclosure. The method 600 may be arranged in accordance with at least one example described in the present disclosure.

The method 600 may be performed by processing logic that may include hardware (circuitry, dedicated logic, etc.), software (such as is run on a computer system or a dedicated machine), or a combination of both, which processing logic may be included in the processing device 802 of FIG. 8, the communication system 700 of FIG. 7, or another device, combination of devices, or systems.

The method 600 may begin at block 605 where the processing logic may monitor, at an access point (AP), a sound.

At block 610, the processing logic may monitor, at the AP, one or more of an image or a video.

At block 615 the processing logic may classify, at the AP, the sound based on one or more of a security condition or a safety condition using one or more of artificial intelligence (AI) or machine learning (ML). The sound may be an intrusion-indicating sound.

At block 620, the processing logic may perform, at the AP, analysis of one or more of the image or the video to verify the one or more of the security condition or the safety condition, using one or more of AI or ML to detect an object. The object may be an intrusion-indicating object.

The processing logic may classify, at the AP, the sound using one or more of the image or the video; or detect, at the AP, the object in one or more of the image or the video using the sound.

The processing logic may train at the AP, a model based on training data and a selected training algorithm to generate a trained model; and perform, at the AP, the one or more of AI or ML using the trained model.

The processing logic may receive, at the AP, data from one or more of an IoT device, a UE, or a smart home system. The data may be used to one or more of classify the sound or perform the analysis of the one or more of the image or the video.

The processing logic may send, from the AP, an alert to one or more of a UE, an IoT device, or a smart home system.

Modifications, additions, or omissions may be made to the method 600 without departing from the scope of the present disclosure. For example, in some examples, the method 600 may include any number of other components that may not be explicitly illustrated or described.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 7 illustrates a block diagram of an example communication system 700 for integrated sound and video monitoring, in accordance with at least one example described in the present disclosure. The communication system 700 may include a digital transmitter 702, a radio frequency circuit 704, a device 712, a digital receiver 706, and a processing device 708. The digital transmitter 702 and the processing device 708 may receive a baseband signal via connection 710. A transceiver 714 may include the digital transmitter 702 and the radio frequency circuit 704.

In some examples, the communication system 700 may include a system of devices that may communicate with one another via a wired or wireline connection. For example, a wired connection in the communication system 700 may include one or more Ethernet cables, one or more fiber-optic cables, and/or other similar wired communication mediums. Alternatively, or additionally, the communication system 700 may include a system of devices that may communicate via one or more wireless connections. For example, the communication system 700 may include one or more devices that may transmit and/or receive radio waves, microwaves, ultrasonic waves, optical waves, electromagnetic induction, and/or similar wireless communications. Alternatively, or additionally, the communication system 700 may include combinations of wireless and/or wired connections. In these and other examples, the communication system 700 may include one or more devices that may obtain a baseband signal, perform one or more operations to the baseband signal to generate a modified baseband signal, and transmit the modified baseband signal, such as to one or more loads.

In some examples, the communication system 700 may include one or more communication channels that may communicatively couple systems and/or devices included in the communication system 700. For example, the transceiver 714 may be communicatively coupled to the device 712.

In some examples, the transceiver 714 may obtain a baseband signal. For example, as described herein, the transceiver 714 may generate a baseband signal and/or receive a baseband signal from another device. In some examples, the transceiver 714 may transmit the baseband signal. For example, upon obtaining the baseband signal, the transceiver 714 may transmit the baseband signal to a separate device, such as the device 712. Alternatively, or additionally, the transceiver 714 may modify, condition, and/or transform the baseband signal in advance of transmitting the baseband signal. For example, the transceiver 714 may include a quadrature up-converter and/or a digital to analog converter (DAC) that may modify the baseband signal. Alternatively, or additionally, the transceiver 714 may include a direct radio frequency (RF) sampling converter that may modify the baseband signal.

In some examples, the digital transmitter 702 may obtain a baseband signal via connection 710. In some examples, the digital transmitter 702 may up-convert the baseband signal. For example, the digital transmitter 702 may include a quadrature up-converter to apply to the baseband signal. In some examples, the digital transmitter 702 may include an integrated digital to analog converter (DAC). The DAC may convert the baseband signal to an analog signal, or a continuous time signal. In some examples, the DAC architecture may include a direct RF sampling DAC. In some examples, the DAC may be a separate element from the digital transmitter 702.

In some examples, the transceiver 714 may include one or more subcomponents that may be used in preparing the baseband signal and/or transmitting the baseband signal. For example, the transceiver 714 may include an RF front end (e.g., in a wireless environment) which may include a power amplifier (PA), a digital transmitter (e.g., 702), a digital front end, an Institute of Electrical and Electronics Engineers (IEEE) 1588v2 device, a Long-Term Evolution (LTE) physical layer (L-PHY), an (S-plane) device, a management plane (M-plane) device, an Ethernet media access control (MAC)/personal communications service (PCS), a resource controller/scheduler, or the like. In some examples, a radio (e.g., a radio frequency circuit 704) of the transceiver 714 may be synchronized with the resource controller via the S-plane device, which may contribute to high-accuracy timing with respect to a reference clock.

In some examples, the transceiver 714 may obtain the baseband signal for transmission. For example, the transceiver 714 may receive the baseband signal from a separate device, such as a signal generator. For example, the baseband signal may come from a transducer that may convert a variable into an electrical signal, such as an audio signal output of a microphone picking up a speaker's voice. Alternatively, or additionally, the transceiver 714 may generate a baseband signal for transmission. In these and other examples, the transceiver 714 may transmit the baseband signal to another device, such as the device 712.

In some examples, the device 712 may receive a transmission from the transceiver 714. For example, the transceiver 714 may transmit a baseband signal to the device 712.

In some examples, the radio frequency circuit 704 may transmit the digital signal received from the digital transmitter 702. In some examples, the radio frequency circuit 704 may transmit the digital signal to the device 712 and/or the digital receiver 706. In some examples, the digital receiver 706 may receive a digital signal from the RF circuit and/or send a digital signal to the processing device 708.

In some examples, the processing device 708 may be a standalone device or system, as illustrated. Alternatively, or additionally, the processing device 708 may be a component of another device and/or system. For example, in some examples, the processing device 708 may be included in the transceiver 714. In instances in which the processing device 708 is a standalone device or system, the processing device 708 may communicate with additional devices and/or systems remote from the processing device 708, such as the transceiver 714 and/or the device 712. For example, the processing device 708 may send and/or receive transmissions from the transceiver 714 and/or the device 712. In some examples, the processing device 708 may be combined with other elements of the communication system 700.

FIG. 8 illustrates a diagrammatic representation of a machine in the example form of a computing device 800 within which a set of instructions, for causing the machine to perform any one or more of the methods discussed herein, may be executed. The computing device 800 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a local area network (LAN), an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 800 includes a processing device (e.g., a processor) 802, a main memory 804 (e.g., read-only memory (ROM), flash memory, dynamic random access memory (DRAM) such as synchronous DRAM (SDRAM)), a static memory 806 (e.g., flash memory, static random access memory (SRAM)) and a data storage device 816, which communicate with each other via a bus 808.

Processing device 802 represents one or more general-purpose processing devices such as a microprocessor, central processing unit, or the like. More particularly, the processing device 802 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 802 may also include one or more special-purpose processing devices such as an application specific integrated circuit (ASIC), a field programmable gate array (FPGA), a digital signal processor (DSP), network processor, or the like. The processing device 802 is configured to execute instructions 826 for performing the operations and steps discussed herein.

The computing device 800 may further include a network interface device 822 which may communicate with a network 818. The computing device 800 also may include a display device 810 (e.g., a liquid crystal display (LCD) or a cathode ray tube (CRT)), an alphanumeric input device 812 (e.g., a keyboard), a cursor control device 814 (e.g., a mouse) and a signal generation device 820 (e.g., a speaker). In at least one example, the display device 810, the alphanumeric input device 812, and the cursor control device 814 may be combined into a single component or device (e.g., an LCD touch screen).

The data storage device 816 may include a computer-readable storage medium 824 on which is stored one or more sets of instructions 826 embodying any one or more of the methods or functions described herein. The instructions 826 may also reside, completely or at least partially, within the main memory 804 and/or within the processing device 802 during execution thereof by the computing device 800, the main memory 804 and the processing device 802 also constituting computer-readable media. The instructions may further be transmitted or received over a network 818 via the network interface device 822.

While the computer-readable storage medium 824 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media, and magnetic media.

In some examples, the different components, modules, engines, and services described herein may be implemented as objects or processes that execute on a computing system (e.g., as separate threads). While some of the systems and methods described herein are generally described as being implemented in software (stored on and/or executed by hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absent a showing that the terms “first,” “second,” “third,” etc., connote a specific order, these terms should not be understood to connote a specific order. Furthermore, absent a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although examples of the present disclosure have been described in detail, it should be understood that the various changes, substitutions, and alterations could be made hereto without departing from the spirit and scope of the present disclosure.

What is claimed is:

1. A system, comprising:
a sound sensor operable to monitor a sound;
a camera operable to capture one or more of an image or a video;
a device comprising a processing device operable to:
classify the sound based on one or more of a security condition or a safety condition using one or more of artificial intelligence (AI) or machine learning (ML), wherein the sound is an intrusion-indicating sound; and
perform analysis of one or more of the image or the video to verify the one or more of the security condition or the safety condition using one or more of AI or ML to detect an object, wherein the object is an intrusion-indicating object,
wherein the device comprises one or more of an internet gateway or an access point (AP).

2. The system of claim 1, wherein the device is operable to classify the sound and perform analysis of the one or more of the image or the video without modifying the processing device when compared to a baseline processing device that does not classify the sound or perform analysis of the one or more of the image or the video.

3. The system of claim 1, wherein the processing device is operable to:
classify the sound using one or more of the image or the video; or
detect an object in one or more of the image or the video using the sound.

4. The system of claim 1, wherein the processing device is further operable to:
train, at the device, a model based on training data and a selected training algorithm to generate a trained model; and
perform, at the device, the one or more of AI or ML using the trained model.

5. The system of claim 1, wherein the processing device is further operable to receive data from one or more of an internet of things (IoT) device, a user equipment (UE), or a smart home system, wherein the data is used to one or more of classify the sound or perform the analysis of the one or more of the image or the video.

6. The system of claim 1, wherein the processing device is further operable to send an alert to one or more of a user equipment (UE), an internet of things (IoT) device, or a smart home system.

7. The system of claim 1, wherein the processing device is a local device.

8. The system of claim 1, wherein:
the intrusion-indicating sound is one or more of a smoke alarm, a baby cry, glass breaking, or a gun-shot; or
the intrusion-indicating object is one or more of smoke, broken glass, a weapon, or an unknown person.

9. A method for intrusion detection, comprising:
monitoring, at an access point (AP), a sound;
monitoring, at the AP, one or more of an image or a video;
classifying, at the AP, the sound based on one or more of a security condition or a safety condition using one or more of artificial intelligence (AI) or machine learning (ML), wherein the sound is an intrusion-indicating sound; and
performing, at the AP, analysis of one or more of the image or the video to verify the one or more of the security condition or the safety condition using one or more of AI or ML to detect an object, wherein the object is an intrusion-indicating object.

10. The method of claim 9, further comprising:
classifying, at the AP, the sound using one or more of the image or the video; or
detecting, at the AP, the object in one or more of the image or the video using the sound.

11. The method of claim 9, further comprising:
training, at the AP, a model based on training data and a selected training algorithm to generate a trained model; and
performing, at the AP, the one or more of AI or ML using the trained model.

12. The method of claim 9, further comprising:
receiving, at the AP, data from one or more of an internet of things (IoT) device, a user equipment (UE), or a smart home system, wherein the data is used to one or more of classify the sound or perform the analysis of the one or more of the image or the video.

13. The method of claim 9, further comprising:
sending, from the AP, an alert to one or more of a user equipment (UE), an internet of things (IoT) device, or a smart home system.

14. The method of claim 9, wherein:
the intrusion-indicating sound is one or more of a smoke alarm, a baby cry, glass breaking, or a gun-shot; or
the intrusion-indicating object is one or more of smoke, broken glass, a weapon, or an unknown person.

15. An access point (AP), comprising:
a processing device operable to:
monitor, at an access point (AP), a sound;
monitor, at the AP, one or more of an image or a video;
classify, at the AP, the sound based on one or more of a security condition or a safety condition using one or more of artificial intelligence (AI) or machine learning (ML), wherein the sound is an intrusion-indicating sound; and
perform, at the AP, analysis of one or more of the image or the video to verify the one or more of the security condition or the safety condition, using one or more of AI or ML to detect an object, wherein the object is an intrusion-indicating object.

16. The AP of claim 15, wherein the processing device is further operable to:
classify, at the AP, the sound using one or more of the image or the video; or
detect, at the AP, the object in one or more of the image or the video using the sound.

17. The AP of claim 15, wherein the processing device is further operable to:
train, at the AP, a model based on training data and a selected training algorithm to generate a trained model; and
perform, at the AP, the one or more of AI or ML using the trained model.

18. The AP of claim 15, wherein the processing device is further operable to:
receive, at the AP, data from one or more of an internet of things (IoT) device, a user equipment (UE), or a smart home system, wherein the data is used to one or more of classify the sound or perform the analysis of the one or more of the image or the video.

19. The AP of claim 15, wherein the processing device is further operable to:
send, from the AP, an alert to one or more of a user equipment (UE), an internet of things (IoT) device, or a smart home system.

20. The AP of claim 15, wherein:
the intrusion-indicating sound is one or more of a smoke alarm, a baby cry, glass breaking, or a gun-shot; or
the intrusion-indicating object is one or more of smoke, broken glass, a weapon, or an unknown person.
